(19) United States
(12) Patent Application Publication
(10) Pub. No.: US 2021/0383406 A1
(43) Pub. Date: Dec. 9, 2021

(54) MANAGING CERTIFICATION AND IMPORTATION INFORMATION FOR SUPPLY CHAINS

(71) Applicant: Physical 2 Digital Limited, Marlow (GB)

(72) Inventors: Ethan Hilsley, Surrey (GB); Barrington Hilsley, Surrey (GB)

(21) Appl. No.: 17/303,767

(22) Filed: Jun. 7, 2021

Related U.S. Application Data
(60) Provisional application No. 63/036,344, filed on Jun. 8, 2020.

(51) Int. Cl. G06Q 30/00; G06Q 10/08

(52) U.S. Cl. CPC G06Q 30/018; G06Q 10/0832; G06Q 10/087

(57) ABSTRACT

Systems and methods are described for implementing a supply chain certification system. Products early in a supply chain may be consumed in the manufacture of later products, and the earlier products may have characteristics (e.g., organic, fair trade, sustainably farmed, sourced from a particular geographic region, etc.) that may or may not be preserved in the later products. The supply chain certification system tracks the manufacture and delivery of products in a supply chain, and may certify that the later products in the supply chain retain the characteristics of the earlier products. For example, the system may verify for a given product that the quantity manufactured does not exceed the quantity that can be manufactured out of the certified raw materials delivered to the manufacturer. The system may also be used to analyze sets of defective products and identify a common “ancestor” product, and to identify manufacturing inefficiencies.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Generally described, a supply chain is a series of products in which earlier products in the chain are consumed in the manufacture of later products. A supply chain may begin, for example, with ingredients or raw materials (e.g., cows, grain, milk, tomatoes, etc.), which may be processed into intermediate products (e.g., ground beef, bread, cheese, tomato paste, etc.) and then further processed or combined into further products (e.g., a cheeseburger, canned pasta sauce, a frozen lasagna, etc.). Supply chains may include products sourced from a variety of different suppliers, who may have different facilities and manufacturing processes.

In some embodiments, supply chains may extend across state or national boundaries. Suppliers may therefore need to comply with different local regulations, including import and export regulations. In other embodiments, suppliers of products in a supply chain may have requirements that other suppliers must satisfy.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a functional block diagram of an example network environment for implementing a supply chain certification system in accordance with aspects of the present disclosure.

FIGS. 2A-2C are block diagrams depicting example interactions between a supply chain certification system, suppliers, and an export control system in accordance with aspects of the present disclosure.

FIG. 3 is a flow diagram depicting an example supply chain certification routine in accordance with aspects of the present disclosure.

FIG. 4 is a functional block diagram of an example computing device for implementing the supply chain certification system in the network environment of FIG. 1.

### DETAILED DESCRIPTION

Generally described, aspects of the present disclosure relate to supply chain management. More specifically, aspects of the present disclosure are directed to systems, methods, and computer-readable media related to a supply chain certification system. A supply chain certification system enables aggregation of raw materials into finished products. The system may be used, for example, to ensure that suppliers in a supply chain are able to certify that their products and/or manufacturing processes comply with various requirements, such as food safety regulations, export regulations, truth-in-advertising requirements (e.g., that products are organic, fair trade, sustainably grown, etc.), designations of origin or geographic region, or other characteristics that may or may not be preserved in a supply chain. In some embodiments, the supply chain certification system may present information to government entities, industry groups, or other parties that enables product composition to be analyzed and presented for certification purposes.

As used herein in various contexts, “supply chain” may refer to individual products that are delivered from one supplier to the next, to a series of such products, to the suppliers, to a “last” product that uses all or some of the prior products in the chain as ingredients or raw materials, or combinations thereof. For example, a supply chain may include a primary supplier of raw beef (e.g., a slaughterhouse or abattoir), a supplier that uses raw beef to make its products (e.g., a meat packing facility), a supplier that uses processed raw beef to make its products (e.g., an industrial food processor), and so forth. In some embodiments, supply chains that involve certain types of products (e.g., products of animal origin, plant origin, wines and spirits, etc.) may be subject to specific regulations and/or export requirements. It will also be understood that, although a number of the examples disclosed herein relate to products intended for human consumption, the present disclosure is not limited to a particular type of product. For example, the system may be used to certify that all of the manufacturers in a product's supply chain complied with certain labor standards or ethical practices.

Suppliers of products in these supply chains may therefore provide information to suppliers further down the chain (i.e., suppliers that consume the previous supplier's product as a raw material or ingredient in the manufacture of their own products) to confirm that the product that is ultimately consumed or exported has complied with regulations or export requirements at every part of the supply chain. However, suppliers may not receive information regarding their suppliers' suppliers further “up” the supply chain, and the information that a supplier passes “down” the supply chain to immediate consumers of its products may not be passed further on. Additionally, suppliers may maintain different and incompatible systems for managing compliance or certification data, and information may be lost in translation as it is passed from one supplier's system to another's.

To resolve these issues and ensure compliance with export regulations and other rules, a supply chain certification system may be implemented as described herein and used to certify compliance throughout a supply chain. The supply chain certification system may be implemented, in some embodiments, as an application programming interface (“API”) or other user interface that supplier systems may use to exchange information, and this system may be implemented as a system or record or source of truth for the supply chain. The supply chain certification system may provide documentation that certifies compliance with regulations to an export control system, and may provide individual suppliers with data that can be viewed, validated, and reused to ensure that the suppliers' suppliers are implementing, for example, approaches such as hazard analysis and critical control points (“HACCP”) to ensure that their products comply with food safety regulations.

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

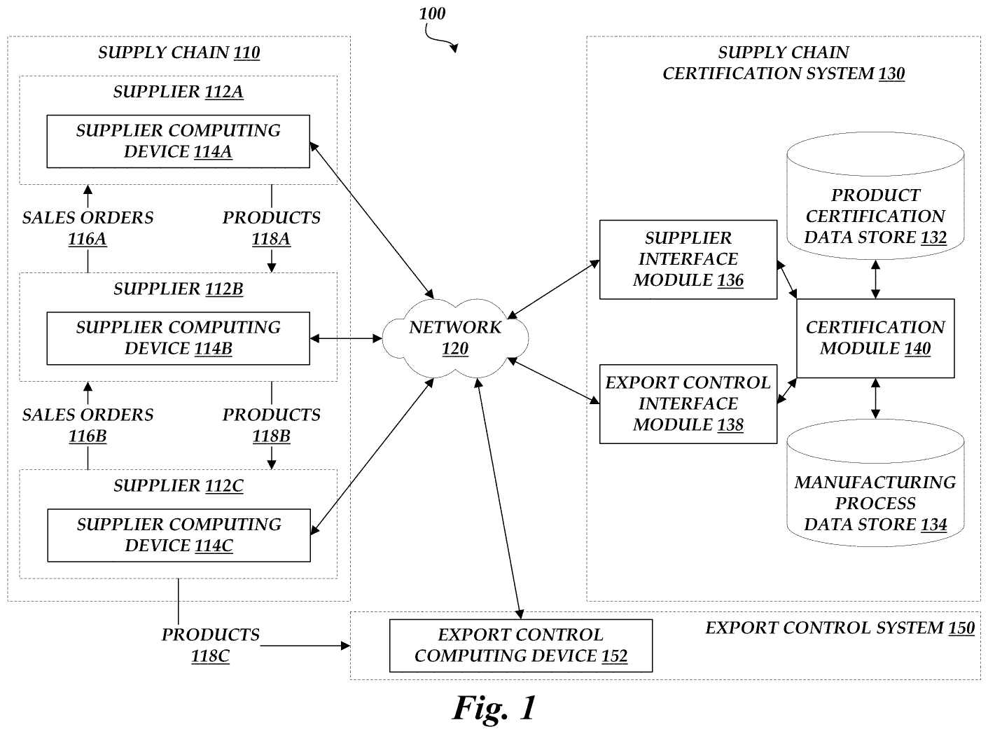

FIG. 1 is a block diagram of an example network environment 100 for implementing a supply chain certification system 130 in accordance with aspects of the present disclosure. The network environment 100 may include a number of suppliers 112A-C, whose supplier computing devices 114A-C may interact with the supply chain certification system 130 via a network 120. The suppliers 112A-C may illustratively be part of a supply chain 110, and the suppliers 112A-C in the supply chain 110 may interact with each other by exchanging, for example, sales orders 116A-B for delivery of products 118A-B. The final supplier 112C in the supply chain 110 may deliver a product 118C, and may for example deliver the product 118C to an export control system 150. It will be understood that FIG. 1 depicts a simplified supply chain 110 with three suppliers 112A-C for purposes of example, and that the present disclosure is not limited to a particular number of suppliers 112A-C or to a linear supply chain 110.

The network 120 may illustratively be any wired or wireless network, or combination thereof. In addition, the network 120 may include, but is not limited to, a cellular telecommunications network, Wi-Fi network, cable network, satellite network, mesh network, personal area network, local area network (LAN), wide area network (WAN), public or private intranet, the Internet, or other public or private communications network or networks, or any combination thereof. In some embodiments, the network 120 may be a private or semi-private network, such as a corporate or university intranet. The network 120 may use protocols and components for communicating via the Internet or any of the other aforementioned types of networks. In some embodiments, the network 120 may be omitted, and one or more of the supplier computing devices 114A-C or the export control computing device 152 may communicate directly with the supply chain certification system 130.

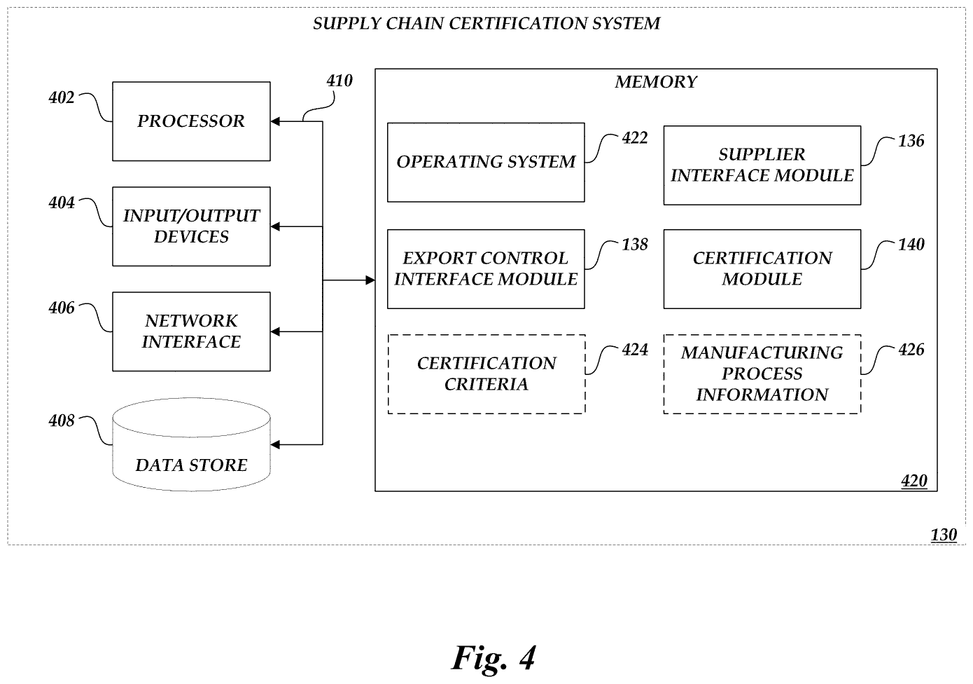

The supply chain certification system 130 is described in further detail with reference to FIG. 4, and may include various elements that implement aspects of the present disclosure. In the illustrated embodiment, the supply chain certification system 130 includes a product certification data store 132, manufacturing process data store 134, supplier interface module 136, export control interface module 138, and certification module 140. The data stores 132 and 134 may illustratively be any non-transient computer-readable data store, including but not limited to hard drives, solid state devices, flash memories, EEPROMs, optical media, and the like. The modules 136, 138, 140 may, in various embodiments, include various arrangements of computer hardware and software that may be used to implement aspects of the present disclosure, as described in more detail below.

The export control system 150 may generally be any system that receives and/or processes the output of the supply chain certification system 130. For example, the export control system 150 may be a system implemented by a government at an international border to control the export or import of goods from one country to another. In some embodiments, the export control system 150 includes an export control computing device 152, which interacts with the supply chain certification system 130 via the network 120. In other embodiments, the export control computing device 152 may be omitted, and supply chain certification information may be delivered to the export control system 150 via other channels (e.g., paper certificates).

It will be understood that the network environment 100 may include more (or fewer) elements than those shown in FIG. 1. It is not necessary, however, that all of these elements be shown in order to provide an enabling disclosure.

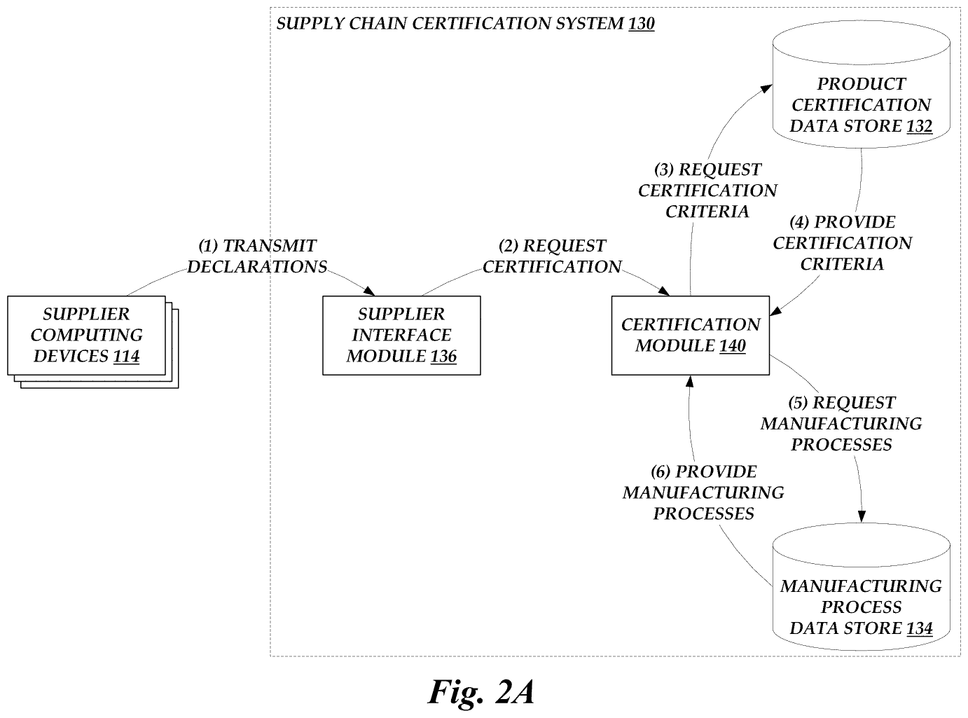

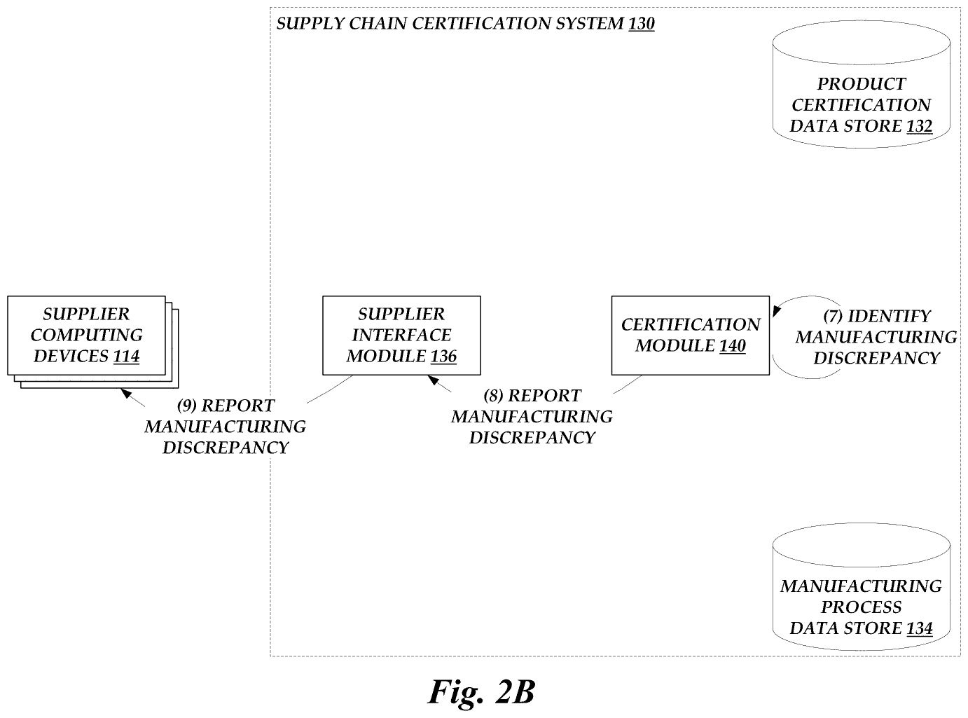

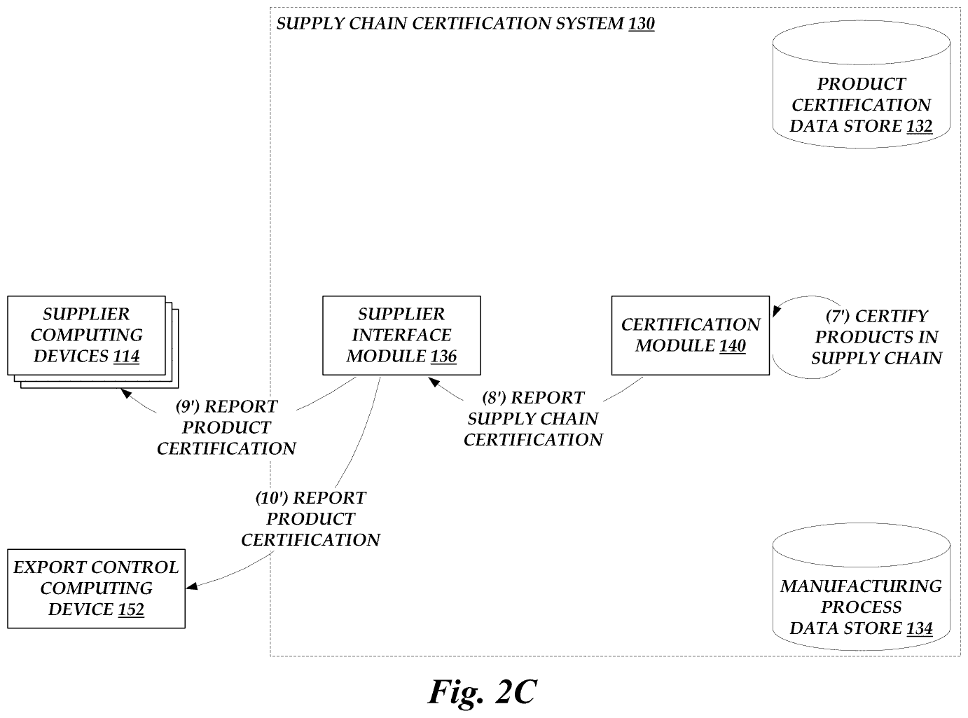

FIGS. 2A-C are block diagrams depicting example interactions for certifying products and/or supply chains in accordance with aspects of the present disclosure. With reference now to FIG. 2A, at (1), supplier computing devices 114 may transmit declarations regarding supplied products to a supplier interface module 136 of a supply chain certification system. The declarations may include, for example, statements regarding a country or region in which the product originated (e.g., that the supplied olives were grown in Italy, that the supplied trees were grown in California, etc.), compliance with various regulations (e.g., that supplier complied with US or EU regulations regarding preparation and handling of the product in question), adherence to specified practices (e.g., that a product was harvested sustainably, farmed or raised organically, fair trade principles were applied, animals were treated humanely, etc.), and the like. In some embodiments, declarations may include characteristics of the product (e.g., perishable, animal origin, vegan, gluten free, prepared in accordance with certain religious practices or dietary laws, etc.), an expiry date or use-by date, or other characteristics that may be relevant or applicable to later products in the supply chain.

At (2), the supplier interface module 136 may pass the received declarations to the certification module 140 and request that the certification module 140 process the declarations and attempt to certify the supply chain. As discussed above, “supply chain” may refer to the individual products that are delivered from one supplier to the next, to a set of such products, to the suppliers themselves, or to a “last” product that uses all or some of the prior products in the chain as ingredients or raw materials. For example, a supply chain may include cows that are delivered from a ranch to a slaughterhouse, raw sides of beef that are delivered from the slaughterhouse to a meatpacking plant, processed cuts of raw beef that are delivered from the meatpacking plant to an industrial food processor, and frozen meals containing beef that are made by the industrial food processor. The certification module 140, in various embodiments, may be used to certify that the frozen beef patties are organic, that the ground beef was properly handled at each stage of the supply chain, that the ranch engaged in “free range” practices and hence later products in the supply chain may so designate their products, and so forth.

At (3) the certification module 140 may request certification criteria from the product certification data store 132. Illustratively, the certification criteria may specify content that declarations must contain (e.g., a statement that the supplier complied with food regulations or used a specified manufacturing process), logical conditions (e.g., that an expiry date associated with a perishable product has not elapsed), or other criteria. At (4), the product certification data store 132 supplied the relevant certification criteria for the product(s) in question.

At (5), the certification module 140 requests information regarding the manufacturing process(es) used to produce the product(s). In some embodiments, the manufacturing process may be a recipe for preparing a particular product, and may specify that a certain amount of a particular ingredient or raw material is consumed when producing a unit of the product. For example, a manufacturing process may specify that producing a liter of olive oil requires at least five kilograms of olives, and thus a supplier who receives 500 kilograms of Italian olives and produces 200 liters of “Italian” olive oil has diluted or mislabeled their product. The manufacturing process and criteria may thus be used to detect supply chain issues. In other embodiments, the manufacturing process may specify a range of consumption or a maximum consumption (e.g., that producing a liter of olive oil requires five to six kilograms of olives), and the certification module 140 may identify a supplier who is making inefficient use of ingredients or raw materials in addition to determining whether the product should be certified. At (6), the manufacturing process data store 134 provides the information regarding the manufacturing process(es) used.

With reference now to FIG. 2B, an example in which a product fails to meet one or more criteria is described. At (7), the certification module 140 identifies an issue with at least one of the products in the supply chain. In the illustrated embodiment, the issue is a manufacturing discrepancy, such as a supplier manufacturing more of a product than is manufacturable from a given set of raw materials or ingredients. In other embodiments, the issue may be that the supplier did not comply with certain regulations or conditions that were needed to maintain a characteristic of the product. For example, the supplier may have mixed organically grown ingredients with other ingredients that were not organic, or may have failed to comply (or failed to attest that they had complied) with dietary or food handling requirements.

At (8), the certification module 140 reports the issue to the supplier interface module 136, which at (9) reports the issue to one or more of the supplier computing devices. In various embodiments, the supply chain certification system 130 may report the issue to the supplier of the product that could not be certified, to consumers of that product (e.g., suppliers who use the nonconforming product as an ingredient or raw material), to an export control system, or to other parties as needed.

In some embodiments, as described above, the supply chain certification system 130 may at (7) detect an inefficiency rather than a certification issue (e.g., that the amount of product manufactured is less than expected, given the raw materials consumed), and may report this inefficiency at (8) and (9). In other embodiments, the supply chain certification system 130 may detect and report that some criteria were satisfied and others were not. For example, the system 130 may report that a set of raw materials satisfied “organic” and “made in UK” criteria, but that a product made from these raw materials only satisfies the “organic” criterion, because the facility at which the raw materials were combined is not in the UK.

With reference now to FIG. 2C, an example in which the supply chain is certified to have meet the relevant criteria is described. At (7′), the certification module 140 certifies the products in the supply chain. In various embodiments, as described above, the certification module 140 may certify products in the supply chain separately, certify them as a set, certify the supply chain itself, or certify that the “last” product in the supply chain meets the criteria. At (8′), the certification module 140 reports these results to the supplier interface module 136. In some embodiments, at (9′), the supplier interface module 136 reports the outcome of certifying the supply chain (and/or the outcome of certifying their particular product) to individual supplier computing devices 114. In some embodiments, at (10′), the supplier interface module 136 produces a certification report that is delivered to an export control computing device 152. Illustratively, the certification report may verify that a product or product complies with export regulations for, e.g., labeling products as sustainably farmed or sourced from a particular geographic region.

It will be understood that FIGS. 2A-2C are provided for purposes of example, and that many variations on the depicted interactions are within the scope of the present disclosure. For example, in some embodiments, the supply chain certification system 130 may provide a report to each supplier at the time the supplier receives raw materials or ingredients from a previous supplier in the supply chain. As a further example, the interactions at (3) and (5) may be carried out in either order or in parallel. FIGS. 2A-2C are thus understood to be illustrative and not limiting.

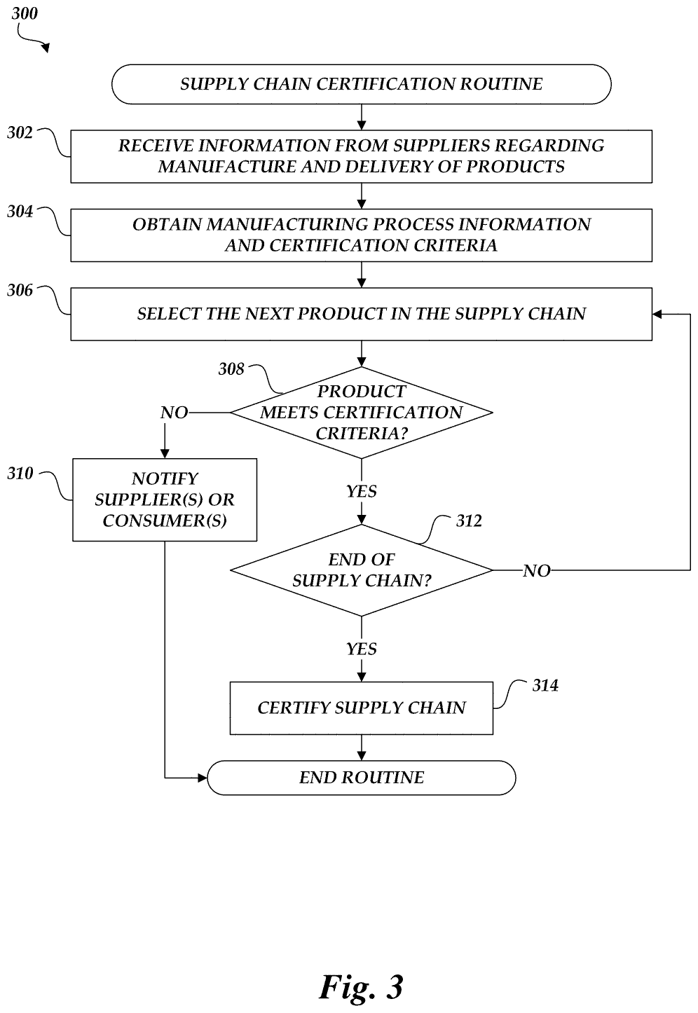

FIG. 3 is a flow diagram depicting an example product certification routine 300 that may be carried out to implement aspects of the present disclosure. The product certification routine 300 may be carried out, for example, by the certification module 140 depicted in FIG. 1. At block 302, information may be received from suppliers regarding the manufacture and delivery of products. The information may include, for example, invoices, bills of lading, and the like regarding products that have been shipped from one supplier to another, and in some embodiments may include statements or declarations by the supplier regarding the product, its manufacture, and so forth. For example, a supplier may attest that lumber was sustainably harvested (e.g., by only taking a portion of the available trees and by planting a new tree for each tree taken), or that a product was sourced from a particular geographic region.

At block 304, certification criteria and manufacturing process information may be obtained. As described above, certification criteria may include conditions that must be met, declarations that must be provided, and other criteria that must be satisfied in order for the product and/or the supply chain to be certified. Manufacturing processes may similarly provide information that enables verification that the outputs of a manufacturing process are consistent with the inputs, as described above.

At block 306, the next product in the supply chain may be selected. Illustratively, the first product in the supply chain will be selected the first time block 306 is carried out, the next product in the chain will be selected the second time block 306 is carried out, and so forth. In some embodiments, the routine 300 may be carried out to certify that a particular product may be certified, and the routine 300 may work backward from that product to the raw materials or ingredients at the start of its supply chain(s). In such embodiments, the supply chain may include branches for various products (e.g., milk, eggs, grain, etc.), each of which must be certified before the final product can be certified.

At decision block 308, a determination may be made as to whether the selected product meets the certification criteria. In some embodiments, as described above, whether a product meets criteria may depend on whether the preceding products in the supply chain meet the criteria. For example, a packaged salad may only be certified as organic if each of the individual ingredients (lettuce, carrots, etc.) can be certified as organic, or a child's stuffed animal may only be certified as “made in USA” if each of its components can be certified as such. In other embodiments (e.g., for the first product in the supply chain), the determination of whether the selected product meets certification criteria may be based on declarations or other information provided by the supplier. In other embodiments, satisfaction of the certification criteria may depend on whether the manufacturing process was followed.

If the determination at decision block 308 is that the product does not meet the certification criteria, then at block 310 the supplier(s) or consumer(s) of the product may be notified. Illustratively, a notification may be generated that the product did not meet a particular criterion, such as that the amount of product manufactured is not consistent with the amount manufacturable from the supplied ingredients, or that the supplier did not attest to its compliance with certain export regulations. If the determination at decision block 308 is that the product and/or the supplier did satisfy the certification criteria, then at decision block 312 a determination is made as to whether further products in the supply chain need to be evaluated. If so, then the routine 300 branches to block 306 and the next product is selected. In some embodiments, as discussed above, the routine 300 may be carried out for multiple branches of a supply chain that extends from a product, and may include multiple suppliers of ingredients, multiple consumers of the product, and so forth. If the determination at decision block 312 is that there are no further products to test, then at block 314 the supply chain (or, in some embodiments, a product) is certified as having met the certification criteria.

It will be understood that FIG. 3 is provided for purposes of example, and that many variations on the example routine 300 are within the scope of the present disclosure. For example, blocks 302 and 304 may be carried out in any order or in parallel, or block 302 may be carried out prior to the execution of the routine 300. As a further example, a determination of whether a product was manufactured according to a specified process may be made separately from whether the product met other criteria. The depicted routine 300 is thus understood to be illustrative and not limiting.

FIG. 4 is an illustrative block diagram depicting a general architecture of a supply chain certification system 130, which includes an arrangement of computer hardware and software that may be used to implement aspects of the present disclosure. The supply chain certification system 130 may include more (or fewer) elements than those displayed in FIG. 4. It is not necessary, however, that all of these elements be shown in order to provide an enabling disclosure.

As illustrated, the supply chain certification system 130 includes a processor 402, input/output devices 404, a network interface 406, and a data store 408, all of which may communicate with one another by way of a communication bus 401. The network interface 406 may provide connectivity to one or more networks (such as the network 120 of FIG. 1) or computing systems and, as a result, may enable the supply chain certification system 130 to receive and send information and instructions from and to other computing systems or services (e.g., the supplier computing devices 114A-C of FIG. 1). In some embodiments, the data store 408 may implement the product certification data store 132, manufacturing process data store 134, or a combination thereof. In other embodiments, the data store 408 may be omitted and the supply chain certification system 130 may use an external data store.

The processor 402 may also communicate to and from a memory 420. The memory 420 may contain computer program instructions (grouped as modules or components in some embodiments) that the processor 402 may execute in order to implement one or more embodiments. The memory 420 generally includes RAM, ROM, and/or other persistent, auxiliary, or non-transitory computer-readable media. The memory 420 may store an operating system 422 that provides computer program instructions for use by the processor 402 in the general administration and operation of the supply chain certification system 130. The memory 420 may further store specific computer-executable instructions and other information (which may be referred to herein as “modules”) for implementing aspects of the present disclosure.

In some embodiments, the memory 420 may include the supplier interface module 136 and the export control interface module 138, which may be executed by the processor 402 to perform various operations, such as generating interfaces utilized by supplier computing devices 114 and export control computing devices 152. The memory 420 may further include the certification module 140, which may carry out routines (e.g., the example routine 300 depicted in FIG. 3) for certifying products or supply chains. The memory 420 may still further include certification criteria 424 and manufacturing process information 426 that are collected via the network interface 406 (or, in some embodiments, obtained from the data store 408) and loaded into the memory 420 as various operations are performed.

While the operating system 422, supplier interface module 136, export control interface module 138, and certification module 140 are illustrated as distinct modules in the memory 420, in some embodiments, the supplier interface module 136, export control interface module 138, and certification module 140 may be incorporated as modules in the operating system 422 or another application or module, and as such, separate modules may not be required to implement some embodiments. In some embodiments, the supplier interface module 136 and export control interface module 138 may be implemented as parts of a single application.

It will be recognized that many of the components described in FIG. 4 are optional and that embodiments of the supply chain certification system 130 may or may not combine components. Furthermore, components need not be distinct or discrete. Components may also be reorganized. For example, the supply chain certification system 130 may be represented in a single physical device or, alternatively, may be split into multiple physical devices. In some embodiments, components illustrated as part of the supply chain certification system 130 may additionally or alternatively be included in other computing devices, such that some aspects of the present disclosure may be performed by the supply chain certification system 130 while other aspects are performed by another computing device.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A computer-implemented method comprising:
receiving, from a plurality of suppliers, data regarding manufacture and delivery of individual products in a supply chain, wherein a first product in the supply chain is consumed to manufacture a second product in the supply chain, and wherein the second product is consumed to manufacture a third product in the supply chain;
determining, for individual products in the supply chain, whether a manufactured quantity of the product exceeds a manufacturable quantity of the product, the manufacturable quantity of the product determined based at least in part on a delivered quantity of a preceding product in the supply chain and a manufacturing process associated with the product, wherein the manufacturing process specifies a quantity of the preceding product consumed per unit of the product manufactured; and
responsive to a determination that the manufactured quantity of a product in the supply chain exceeds the manufacturable quantity of the product:
associating a manufacturing discrepancy with the product;
generating a notification regarding the manufacturing discrepancy, the notification identifying one or more of the product, a supplier of the product, the manufactured quantity, and the manufacturable quantity; and
transmitting the notification to one or more potential consumers of the product.

2. The computer-implemented method of claim 1, wherein the preceding product in the supply chain comprises one or more of a perishable product, an organic product, a fair trade product, a product that is sustainably or ethically manufactured, a product of animal origin, or a product from a specified geographical region.

3. The computer-implemented method of claim 1, wherein the data regarding manufacture and delivery of individual products in the supply chain includes one or more of a quantity of the first product delivered by a first supplier, a quantity of the first product received by a second supplier, a quantity of the first product consumed by the second supplier, a quantity of the first product remaining in an inventory of the second supplier, or a quantity of the second product delivered by the second supplier.

4. The computer-implemented method of claim 1, wherein the preceding product in the supply chain comprises a perishable product, and wherein the manufacturable quantity of the product is determined based at least in part on an expiry date of the perishable product.

5. The computer-implemented method of claim 4, wherein an expiry date of the product is determined based at least in part on the expiry date of the perishable product.

6. A system comprising:
a data store configured to store computer-executable instructions; and
a processor in communication with the data store, wherein the computer-executable instructions, when executed by the processor, configure the processor to perform operations including:
for individual products in a supply chain, determining, based at least in part on a preceding product in the supply chain, whether the product satisfies one or more certification criteria; and
responsive to a determination that a product in the supply chain does not satisfy at least one of the one or more certification criteria:
associating a manufacturing discrepancy with the product;
generating a notification regarding the manufacturing discrepancy; and
causing transmission of the notification to one or more potential consumers of the product.

7. The system of claim 6, wherein the one or more potential consumers of the product include one or more suppliers that directly or indirectly use the product to manufacture other products in the supply chain.

8. The system of claim 6, wherein the notification regarding the manufacturing discrepancy identifies one or more downstream products, wherein the product associated with the manufacturing discrepancy was consumed to manufacture the one or more downstream products.

9. The system of claim 6, wherein the product associated with the manufacturing discrepancy comprises one or more of a mislabeled product or a contaminated product.

10. The system of claim 6, wherein the data store is configured to store further computer-executable instructions that, when, executed by the processor, configure the processor to perform further operations including:
determining a threshold manufacturable quantity for individual products in the supply chain.

11. The system of claim 10, wherein determining the threshold manufacturable quantity for a product in the supply chain is based at least in part on:
identifying an expired quantity of a preceding product in the supply chain; and
subtracting the expired quantity of the preceding product from a delivered quantity of the preceding product.

12. The system of claim 10, wherein determining the threshold manufacturable quantity for a product is based at least in part on a manufacturing process for the product, and wherein the manufacturing process for the product specifies a quantity of a preceding product that is consumed to manufacture the product.

13. The system of claim 12, wherein the manufacturing process comprises a recipe.

14. The system of claim 12, wherein the manufacturing process specifies a plurality of preceding products.

15. The system of claim 6, wherein a threshold manufacturable quantity for a product is determined based at least in part on an available quantity of a preceding product.

16. Non-transitory computer-readable media storing computer-executable instructions that, when executed by a processor, configure the processor to perform operations including:
for individual products in a supply chain, determining, based at least in part on a preceding product in the supply chain, whether the product satisfies a certification criterion; and
responsive to a determination a product in the supply chain does not satisfy the certification criterion:
generating a notification regarding the product that does not satisfy the certification criterion; and
causing transmission of the notification to a potential consumer of the product.

17. The non-transitory computer-readable media of claim 16 storing further computer-executable instructions that, when executed by the processor, configure the processor to perform further operations including:
obtaining information identifying a set of products associated with a defect, the set of products associated with a first set of suppliers;
identifying, as a defective product, a preceding product that was consumed in the manufacture of each of the set of products associated with the defect;
identifying a second set of suppliers based at least in part on the preceding product;
generating a defective product notification regarding the defective product; and
causing transmission of the defective product notification to the second set of suppliers.

18. The non-transitory computer-readable media of claim 17, wherein each supplier of the second set of suppliers is associated with a manufacturing process that consumes the defective product.

19. The non-transitory computer-readable media of claim 17, wherein the second set of suppliers includes the first set of suppliers.

20. The non-transitory computer-readable media of claim 16 storing further computer-executable instructions that, when executed by a processor, configure the processor to perform further operations including determining, for individual products in the supply chain, that a manufactured quantity of the product is a threshold quantity or percentage below a manufacturable quantity of the product.
